(19) United States
(12) Patent Application Publication
(10) Pub. No.: US 2007/0140195 A1
(43) Pub. Date: Jun. 21, 2007

(54) METHOD AND SYSTEM FOR PROVIDING IP SERVICES USING CABLE AND WIRELESS INFRASTRUCTURE

(76) Inventor: Ilan Kaftan, (US)

Correspondence Address: Ilan Kaftan, 267 Alicia Way, Los Altos, CA, 94022, US

(21) Appl. No.: 11/563,945

(22) Filed: Nov. 28, 2006

Related U.S. Application Data
(60) Provisional application No. 60/751,652, filed on Dec. 20, 2005.

(51) Int. Cl. H04Q 7/24

(52) U.S. Cl. 370/338

(57) ABSTRACT

One embodiment of a Wireless Access Point system for use in a hybrid wireless/cable network, the system capable of authenticating a communication device (mobile and non-mobile) via DOCSIS and/or DOCSIS-compatible protocol and providing the IP service to the mobile device in accordance with a result of the authentication, including QoS downstream and upstream as defined by DOCSIS. In addition, the Wireless Access Point system may comprise one or more virtual cable modems capable of receiving a wireless MAC address of at least one communication device and converting the wireless MAC address into a DOCSIS MAC address associated with the communication device. The virtual cable modem may be also capable of sending the converted MAC address via DOCSIS and/or DOCSIS-compatible protocol and facilitating an access to at least one IP service associated with said MAC address. In one embodiment, a method of facilitating an access of a communication device an IP service provided in a hybrid wireless/cable network, the method comprising authenticating a communication device via DOCSIS and/or DOCSIS-compatible protocol and providing the IP service in accordance with a result of authentication.

### CROSS-REFERENCE TO RELATED APPLICATIONS

This application claims the benefit of provisional patent application Ser. No. 60/751,652, filed 2005 Dec 20 by the present inventor.

### FEDERALLY SPONSORED RESEARCH

Not Applicable

### SEQUENCE LISTING OR PROGRAM

Not Applicable

### BACKGROUND

1. Field of the Invention

The present invention relates to methods and systems for providing video, data and voice services for mobile and/or nomadic communication devices via hybrid cable/wireless network infrastructure.

2. Prior Art

Recent years have brought a growing demand for service providers to roll out the triple play of voice, video and data. Some providers are even adding the fourth element, mobile phone data services to create, the quadruple play. Adding more attractive services has become an essential part of the wining strategy for cable operators, as they are called today Multiple Service Operators (MSOs), who want to stay ahead of the competition.

The growing market for video and data is the mobile market, which currently focuses on services to cellular phones. Solutions for other mobile sectors, such as mobile and nomadic communication devices in cars, buses, mobile laptops, etc. are scarce. To support true video and data services for the mobile sector, a wireless network with high bandwidth, long distance and roaming capability is needed. The two potential wireless technologies that can best satisfy both video and data needs for mobile devices are 3GPP and WiMAX 802.16e. The new WiMAX 802.16e (802.20) is highly scaleable, modular and cellular, an all IP/Ethernet protocol wireless communications system. Although early WiMAX will only be fixed to nomadic the road map calls for rapid progression to CPE, device assisted laptop, and later ‘true mobile’ capability.

The combination of a local wireless network (such as a WiMAX network) with the dense deployment of the cable network (HFC) in urban and suburbs areas creates a new Hybrid network. This network allows MSOs to add video and data services for the mobile sector, cars, buses, nomadic laptop etc.

The problem of creating infrastructure compatible with the Data-Over-Cable Service Interface Specifications (DOCSIS) standard and combining the wireless network with the fixed cable network was recognized in the Prior Art and various systems were developed to provide a solution, for example:

U.S. Pat. No. 6,377,782 discloses a method of upstream communication over a linear broadband network includes the steps of generating an upstream baseband signal and modulating it onto an upstream wireless radio frequency carrier to produce a first upstream modulated carrier signal. The modulated carrier signal is transmitted wirelessly, received, and demodulated to reproduce the information integrity of the upstream baseband signal. The signal is then modulated onto an upstream linear broadband radio frequency carrier for transmission on the linear broadband network. Advantageously, noise that accumulates at the subscriber premises is removed from the upstream signal prior to presentation of the signal to the upstream path of the linear broadband network. A system for communicating over a linear broadband network includes network access interface devices coupled to the linear broadband network. A subscriber access interface device accepts upstream communication signals and modulates and transmits the signal to the network access interface device. The network access interface device 6 receives and demodulates the signal and then modulates it for transmission on the linear broadband network.

US Patent application 2003/128,681 discloses ARC implementation in a fixed wireless communication system utilizing a demand access MAC, such as DOCSIS, and variable length PDUs, such as Ethernet packets, in messages between a base station and CPE. The base station inserts a sequence number into each PDU. The sequence numbers are members of a series, adjacent ones differing by the same factor. The CPE determines if any sequence number/s is/are missing from the packets of a received message, indicating a failure to receive their associated packets. The missing sequence numbers are included in a message back to the base station, which uses them to re-send the missing packets. The series may be generated according to a rule or algorithm available to both the base station and the CPE.

US Patent application 2004/103,442 discloses a service channel used in a bi-directional communications network such as a DOCSIS cable modem system, fixed broadband wireless system, or other network to transmit in the upstream direction. The service channel communications do not require a properly functioning downstream communications link to operate. Remote devices may thusly be able to indicate to a central server various status related data that may assist in identifying problems with the network or aid in proper installation of devices on the network.

US Patent application 2004/255,332 discloses an apparatus and method to allow the extension of a DOCSIS cable modem service over a wireless link. According to the invention a wireless hub transceiver is connected to a distribution coax cable of a DOCSIS based system. The downstream data are transferred over a wireless link to a remote subscriber radio frequency (RF) unit connected to a cable modem that provides the downstream data to the subscriber. Similarly, upstream data are sent from the subscriber cable modem over the wireless link to the wireless hub transceiver where such data are inserted back to the distribution coax cable.

US Patent application 2005/55,729 discloses a TV broadcasting system comprising an outward broadcast link to reach each of a plurality of user receiver installations via satellite or via a terrestrial channel and a return link from each of said plurality of users, said return channel being a terrestrial channel via a wide area network, typically a WAN, of which WAN said user receiver installations form a node. The WAN may also support an uplink. A satellite or terrestrial receiver installation is modified with an extra terrestrial antenna for the WAN and a splitter combiner allows the already installed cable link to the TV receiver to be retained. A residential gateway allows a household LAN and communication enabled devices to be supported via the TV/WAN infrastructure.

US Patent application 2005/84,004 discloses a user-device combining a DOCSIS modem and an up-converter radio circuit to convert upstream traffic signals from the modem output from the 5-42 MHz range to the Lower 700 MHz Band. This up-converted signal is amplified and transmitted from an antenna, which may be located external to the device, or inside the device. A local oscillator provides the upconverter radio circuit with a periodic signal having a frequency that is sufficiently different from the combined signal from the up-converter so that filtering the periodic signal from the combined signal does not require as precise tuning as if the carrier frequencies of the periodic signal and the combined signal were closer in frequency. A diplex filter, with the antenna electrically on one side and the up-converter radio circuit and a downstream amplifier on the other, separates upstream and downstream traffic from a single antenna connection.

US Patent application 2005/94,632 discloses an apparatus and method implementing an automatic repeat request (ARQ) protocol in a DOCSIS wireless environment for fixed wireless applications. More specifically, an ARQ protocol is implemented at the medium access control (MAC) layer to provide fast response relative to convention ARQ protocols and logic that are implemented at higher layers (e.g., TCP/IP) in the OSI layered approach to system architecture and design. To achieve this result, a DOCSIS defined signal and header is modified to include an ARQ header containing various ARQ parameters. While some known approaches to ARQ involve retransmission of entire frames or blocks, the present invention contemplates provide control down to the packet data unit (PDU) level. To achieve this level of granularity, the ARQ header includes sequence numbers within each ARQ header. Accordingly, a transmitter retransmits a lost transmission whenever it receives a “non-acknowledge” signal advising it of the failure and of the identity of the missing PDU.

US Patent application 2005/144,649 discloses a DOCSIS cable modem service which can be extended by providing wireless links that connect users that are beyond the physical reach of the system. This may require that the downstream data are transferred over a wireless link to a remote subscriber radio frequency (RF) unit connected to a cable modem that provides the downstream data to the subscriber. Similarly, upstream data are sent from the subscriber cable modem over the wireless link to the wireless hub transceiver, where such data are inserted back to the distribution coax cable. This insertion causes the injection of noise into the DOCSIS cable modem system. Connecting a plurality of such devices can cause noise beyond the system limitations. By using a burst detect system, the RF receiver portion of the device is connected to the DOCSIS cable only when injecting data upstream, thereby reducing the overall noise injection.

GB Patent application 2,361,145A1 discloses a system comprising a DOCSIS-compatible cable modem network system having a data input couplable to the Internet; a radio frequency transmitter coupled to the cable modem network system and to a transmit antenna; at least one radio frequency receiver coupled to a receive antenna; and at least one DOCSIS-compatible cable modem coupled to the microwave receiver and having a data output. Internet Protocol data may thus be communicated over a wireless link.

GB Patent application 2,373,404A1 discloses a method of adapting communications apparatus to operate using an alternative receiver, the communication apparatus comprising a transceiver having a modem interface connector, and a modem having an rf interface connector, the modem interface connector of the transceiver being connected to the rf interface connector of the modem, the method comprising, providing a said alternative receiver, the receiver having a transmit output connector and a modem interface connector, disconnecting the modem interface connector of the transceiver from the RF interface connector of the modem, connecting the rf interface connector of the modem to the modem interface connector of the receiver, and connecting the modem interface connector of the transceiver to the transmit output connector of the receiver, whereby signals received by the modem are received from the alternative receiver. Preferably the modem is a cable modem such as a DOCSIS-compatible cable modem. The invention also provides a receiver for adapting a wireless communications system comprising a transceiver and a modem, to operate in a frequency range of the receiver, the receiver comprising, a modem interface, a transceiver interface, an antenna interface, a receiver module having an input coupled to the antenna interface and an output coupled to the modem interface, and a transmit filter coupled between the modem interface and the transceiver interface. The invention simplifies the upgrading of subscriber-end apparatus in a wireless communications system, and provides a receiver to facilitate such simplified upgrading.

GB Patent application 2,374,492A1 discloses a base station for a wireless data communication system, for serving a plurality of system users located in a base station service area. The base station has one or more transmitters for transmitting data to the system users on at least two different frequencies and is configured to transmit data for a first subset of the system users at a first data rate on a first frequency and using a first bandwidth, and to transmit data for a second subset of the system users at a second data rate on a second frequency and using a second bandwidth, the first data rate and first bandwidth being different to second data rate and second bandwidth. Providing a base station transmitting using two different bandwidths to two separate subsets of users allows optimization of the available frequency spectrum. Preferably the first and second frequencies and bandwidths define first and second channels, for example a DOCSIS and a Euro-DOCSIS channel, the channels occupying substantially adjacent parts of wireless spectrum.

### SUMMARY

There is a need in the art to provide for a new system and method enabling seamless delivery of IP services via hybrid wireless/cable infrastructure for nomadic and/or mobile users. The invention, in some of its aspects, is aimed to provide a novel solution capable of eliminating a need of adaptation a cable part of said hybrid infrastructure and/or a modification in a regular service workflow (e.g. additional user's authentication, authorization, subscription management, QoS provisioning, etc. when providing communicating (e.g. voice, data, video, etc. and combinations thereof) services for a user with a nomadic and/or mobile communication device.

Thus, the invention may enable a Multiple Service Operator (MSO) to retain its customer base while competing on an equal footing with the wireless operators. Also, the MSO may be enabled to deliver wireless voice, data and video services to the consumer—just as a wireless operator would—while effectively leveraging the MSO—s existing infrastructure.

In accordance with certain aspects of the present invention there is provided a Wireless Access Point system for use in a hybrid wireless/cable network, the system capable of authenticating a communication device (mobile and non-mobile) via DOCSIS and/or DOCSIS-compatible protocol and providing the IP service to the mobile device in accordance with a result of the authentication.

In accordance with further aspects of the present invention, the Wireless Access Point system may comprise one or more virtual cable modems capable of receiving a wireless MAC address of at least one communication device and converting the wireless MAC address into a DOCSIS MAC address associated with the communication device. The virtual cable modem may be also capable of sending the converted MAC address via DOCSIS and/or DOCSIS-compatible protocol and facilitating an access to at least one IP service associated with said MAC address.

In accordance with further aspects of the present invention, there is provided a method of facilitating an access of a communication device an IP service provided in a hybrid wireless/cable network, the method comprising authenticating a communication device via DOCSIS and/or DOCSIS-compatible protocol and providing the IP service in accordance with a result of authentication.

In accordance with further aspects of the present invention, the method may comprise receiving a wireless AC address of at least one communication device and converting the wireless MAC address into a DOCSIS MAC address associated with the communication device. The method may further comprise sending the converted MAC address via DOCSIS and/or DOCSIS-compatible protocol and facilitating an access to at least one IP service associated with said MAC address.

In accordance with further aspects of the present invention there is provided a method of providing IP service for at least one communication device in a hybrid wireless/cable network providing at least one IP service, wherein the access to the IP service is provided in accordance with the aspects above.

### DRAWINGS—FIGURES

In order to understand the invention and to see how it may be carried out in practice, a preferred embodiments will now be described, by way of non-limiting example only, with reference to the accompanying drawings, in which:

FIG. 1 is a schematic block diagram of typical hybrid cable/wireless network architecture as is known in the art and typical work-flow thereof.

FIG. 2 is a schematic block diagram of hybrid cable/wireless network architecture and typical workflow thereof in accordance with certain embodiments of the present invention.

FIG. 3 is a generalized block diagram of the wireless access point functional architecture in accordance with certain embodiments of the present invention.

FIG. 4 is a generalized workflow of authentication and authorization process in accordance with certain embodiments of the present invention.

FIG. 5 is a generalized workflow of QoS adaptation process in accordance with certain embodiments of the present invention.

### DETAILED DESCRIPTION—PREFERED EMBODIMENTS

In the following detailed description numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. In the drawings and description, identical reference numerals indicate those components that are common to different embodiments or configurations.

Embodiments of the present invention may use terms such as, processor, computer, apparatus, system, sub-system, module, unit, device (in single or plural form) for performing the operations herein. This may be specially constructed for the desired purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, Disk-on-Key, smart cards (e.g. SIM, chip cards, etc.), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions capable of being conveyed via a computer system bus.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The term “communication device” used in this patent specification should be expansively construed to cover any kind of CPE (customer premises equipment) device with communication capabilities, including those adapted for coupling with voice, data, video and/or multimedia services, The “communication devices” include fixed (e.g. DECT) and cellular phones, personal and other computers, pagers, radio telephones, dedicated data units (e.g. PDA), TV set-up boxes, digital media centers, wireless information devices (e.g. car control computers, remote security units, industrial processes control units, remote monitoring units, etc.), wireless adapter devices, play stations, etc. etc. The communication device may communicate with another communication device or width other devices (e.g. servers, public switches, service platforms, etc.) via any of possible networks such as, e.g. fixed line network, cellular networks, broadband networks, data communication networks, Internet network, cable networks, etc. and combinations thereof.

The term “IP services” used in this patent specification should be expansively construed to cover any kind of communication services (e.g. data, video, voice, messaging, multi-media applications, etc.) delivering in association with IP packets.

The term “mobile device” used in this patent specification should be expansively construed to cover any kind of communication device used by a mobile and/or nomadic user.

The references cited in the background teach many principles of communication services in a hybrid cable/wireless infrastructure that are applicable to the present invention. Therefore the full contents of these publications are incorporated by reference herein where appropriate for appropriate teachings of additional or alternative details, features and/or technical background.

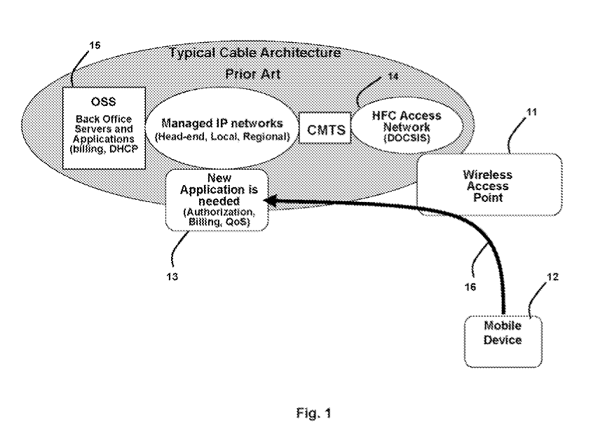

Bearing this in mind, attention is drawn to FIG. 1 illustrating a generalized block diagram of typical hybrid cable/wireless network architecture as is known in the art and typical workflow thereof. The illustrated infrastructure comprises Wireless Access Point 11 giving cable operators the ability to offer Hotspot and High-Speed IP services. A request for service received from a communication device of nomadic and/or mobile user 12 (further referring herein as “mobile device”) is forwarding to an application provider 13, while the communication device is anonymous for the DOCSIS 14 and OSS 15. The device communicates 16 with the AP and than over the open link (always open by the AP) to the new application 13 for authorization etc. The device is always anonymous to the DOCSIS and OSS.

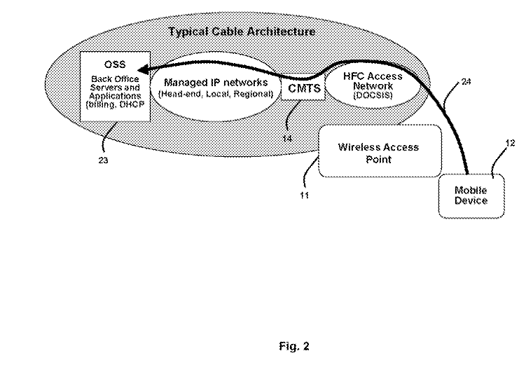

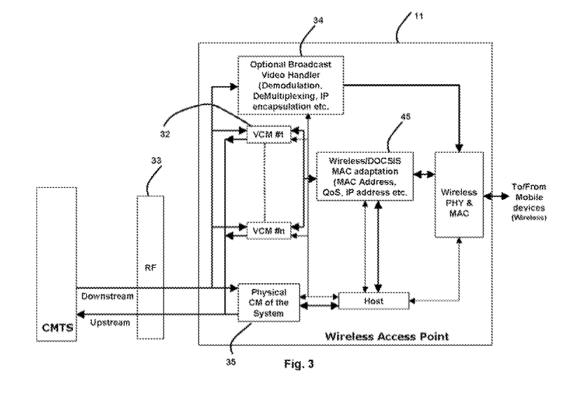

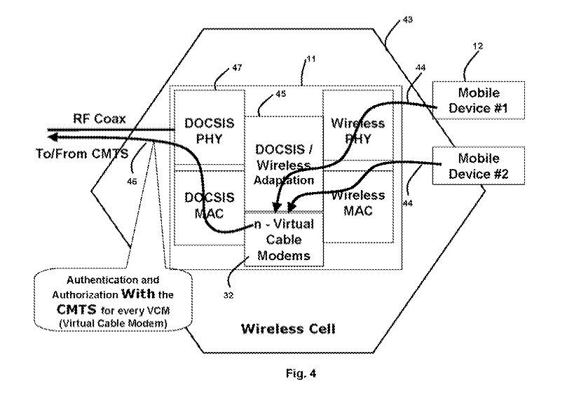

Referring to FIG. 2, there is schematically illustrated a generalized block diagram of hybrid cable/wireless network architecture and workflow thereof in accordance with certain embodiments of the present invention. As will be further detailed with reference to FIGS. 3 and 4, the Wireless Access Point 11, is modified in order to facilitate recognition of a mobile device 25 by CMTS 22, and the OSS 23, using the DOCSIS-compatible protocols 24. The device communicates 24 with the CMTS and the OSS using the DOCSIS (facilitated by virtual cable modem in the AP). The device is known to the DOCSIS and OSS and it is not anonymous.

Thus, in according with certain aspects of the present invention, the provided solution seamlessly connects the wireless network and the cable network. The solution transforms data from the cable network, which is received using the Data Over Cable Service Interface Specification (DOCSIS) or DOCSIS compatible protocol, in, for example, PacketCable standards for Voice Over IP (VoIP) and video transmission into MPEG-2 transport Stream (TS) over Quadrature Amplitude Modulation (QAM) over the existing RF spectrum, or encapsulated into IP at the head-end and then delivered to the wireless base station over DOCSIS (such as, for example DOCSIS 3.0). The wireless network can be based on several wireless standards, such as, but not limited to, the WiFi 802.11, 802.11e, 802.11g, 802.11n, WiMAX 802.16, 802.16e or 802.20 standards as well as to 3G wireless standards. Quality of Service (QoS) adaptation between DOCSIS and the wireless protocol for each mobile device is also provided by the proposed solution. It supports both downstream and upstream adaptation to ensure the right QoS for the video, data and voice services, as defined by the cable operator using the DOCSIS QoS protocol. Maintaining the QoS of DOCSIS on the wireless network facilitates more robust and reliable delivery of various services, based on what the customer paid-for when he subscribed to the service.

The Wireless Access Point in accordance with present invention enables a cable operator to add a new service with no need to change any hardware of the DOCSIS system, the PacketCable system, video transmission system or other service delivery infrastructure. In accordance with certain embodiments of the present invention, there is no need of pre-loading user information in the Wireless Access Point, and, accordingly, the subscribed services may be provided regardless of the end user's location.

Typically, on the cable network, data is delivered by the Cable Modem Termination System (CMTS) located at the head end or at the hub, downstream to the Wireless Access Point by use of the DOCSIS standards. Voice is also delivered by the CMTS system, encapsulated into IP packets, and treated as data based on the PacketCable standard. Video is delivered downstream to the Wireless Access Point using one of three methods: broadcast, narrowcast and IP streaming (including real-time video streaming, like multicast or unicast). The broadcast mode allows the transmission of video broadcast to all vehicles or mobile devices as described later, and it will downstream to the Wireless Access Point as it is done to deliver video to subscribers' premises. Narrowcast method is used to deliver a specific video content which is relevant to a specific area, to the end user who are located (or moving) at that area. Some examples for such content are local advertising on mobile phone or vehicle, construction hazard to a vehicle traveling in a specific zone and more. The IP streaming mode is video encapsulated in IP packets and it is treated as data using the CMTS system (with higher QoS), to guarantee low jitter and delay. This infrastructure integrates with a network that conforms to the PacketCable specifications.

In accordance with certain embodiments of the present invention, on the upstream, the CMTS system will get data, voice and video from the Wireless Access Point all using IP packets. As will be further detailed with reference to FIGS. 3 and 4 every mobile device may be treated by the CMTS as if it has a cable modem attached to it. For the voice service, the PacketCable standard defines a Multi-media Terminal Adapter (MTA), which in mobile voice services can reside inside the mobile phone. Another method to be used is when dedicated software is added at the head-end to deal with the authorization of a mobile device. In such a case, the Wireless Access Point is used as a cable modem and the devices are CPEs that need to be authorized at higher level above the CMTS based on the end user (subscriber) paid service. The two methods are supported by the Wireless Access Point in accordance with certain embodiments of the present invention.

On the wireless network, distinguish is made between video that is received by the Wireless Access Point as MPEG-2 TS (not encapsulated into IP packets) and other data received as IP packets from the CMTS. The video, which is either broadcast or narrowcast, is transmitted downstream to the end user devices over a dedicated channel (sector) while other IP data use a different channel. All the specifications of the 802.11, 802.11e, 802.11n, 802.16, 802.16e or 802.20 standards and of the 3G wireless standards are supported on both downstream and upstream with the exception of the video channel in broadcast method. If the video is received as video over IP, it will be either transmitted on different channel in case of broadcast/multicast channels, or together with the data and voice in case of unicast.

Note that the invention is not bound by the specific network architecture described with reference to FIGS. 1 and 2. Those versed in the art will readily appreciate that the invention is, likewise, applicable to any network including cable and wireless parts. The functions of the Wireless Access Point (or part of them) may be implemented in a stand-alone server(s) (as illustrated in FIG. 2), distributed between several platforms or integrated within other network elements. The Wireless Access Point in accordance with present invention may be also located at a moving vehicle, that communicates with the wireless network. Those versed in the art will readily appreciate that the invention is, likewise, applicable to non-mobile communication devices with no assigned cable modems.

Referring, to FIG. 3, there is illustrated a generalized block diagram of the Wireless Access Point 11 in accordance with certain embodiments of the present invention. A Wireless Access Point in accordance with current invention may be installed on the network in a manner similar to Wireless Access Points known in the art, for example at the local optical node area. The Wireless Access Point may support any wireless systems, for example such as those based on the standards: 802.11, 802.11e, 802.11g; 802.11n, 802.16, 802.16e or 802.20 as well as 3G. The Wireless Access Point may receive video, data, voice and/or any other IP service from the RF or optical lines of the HFC network, and transmit them over the wireless network to the end user such as, for example, a vehicle, laptop or hand held terminal, mobile phone or any other communication device.

The coverage of the Wireless Access Point depends on many parameters such as obstacles in the area, etc., but NLOS (non-line of sight), LOS (line of sight) and/or other known solutions allow to continue reception by the mobile device. An overlap between adjutants Wireless Access Point may enhance the reception and guarantee continuous service while the mobile device is moving from an area covered by one Wireless Access Point to an area covered by a different Wireless Access Point.

The Wireless Access Point is connected to the HFC plant at the RF 33 point (using TAP) or at the optical point, before or after the optical node. We will describe an example in which the box is hooked to the RF 33 cable coming out from the optical node, but it should be appreciated that other configurations are possible and are included in the present invention. Several options are available in order to mount the box: for example, on a strand, on a pedestal, on a wall or on a roof. The antenna can be mounted to the box, to the roof or to the next pole.

Those skilled in the art will readily appreciate that the invention is not bound by the configuration of FIGS. 3, equivalent and/or modified functionality may be consolidated or divided in another manner.

In accordance with certain aspects of the present invention, the Wireless Access Point comprises one or more virtual cable modems 32 (VCM) and or more DOCSIS physical interface (PHY) 47. Each VCM may provide the same functions (or part of them) as a standard cable modem and it is sharing the DOCSIS PHY 47 inside the access point with other virtual cable modems. In addition to these functions, the virtual cable modem is able to facilitate the following process schematically illustrated in FIG. 4:
a) to receive a request 44 for an IP service from a mobile device 12 when the mobile device is establishing a communication with the Wireless Access Point 11 over a wireless protocol 43 (e.g. WiMAX);
b) to recognize a unique MAC address of the mobile device;
c) to convert 45 the received wireless MAC into a DOCSIS MAC;
d) to contact the CMTS via DOCSIS protocol 46 and to forward the recognized MAC address as if it's a MAC address of the VCM;
e) to verify using the DOCSIS protocol that the device with said MAC address can actually get the services, QoS, etc.
f) once the MAC address has been authorized, to receive IP address and to send this IP address to the mobile device and, thus, to facilitate the access to IP service, wherein QoS of the service shall be based on the user profile as shown on the DOCSIS system.

The above process is initiated per each service request of a mobile device. In certain embodiments of the invention the VCM may be disconnected from the CMTS after above access facilitating process or after the mobile device is no longer under the access point coverage area.

Video Handling:

There are several modes, which may be implemented for video handling 34. For example, in one mode the video is received on one of the RF spectrum channels and based on the video channels that need to be downstream to the devices, a specific frequency is selected: a 6 MHz slice in the USA and a 8 MHz in the rest of the world. The tuner inside the box locks itself to the desired frequency, takes down the signal back to IF and than demodulate it (using QAM demodulator) back to MPEG-2 TS (MPEG-2, H.264 or VC-1 depends on the video codec technology been used). The video is then encapsulated to a specific MAC protocol based on the wireless technology being used. In another mode, the video is already encapsulated into IP packet all the way from the head-end, and in this case it will be treated as pure data with higher QoS and will be transmitted as multicast over the wireless network to a group of users similar to broadcast or as unicast when a user selects a specific channel or a specific advertisement is sent to him. On non-data mode, a subset of the 3G, WiFi, WiMAX or 802.20 MAC protocol will be used for the downstream transmission. A single channel in the wireless network (Either in WiMAX or in other technologies) will be dedicated to video in order to guarantee minimum video jitter. Acknowledge is not mandatory back from the device, but is supported.

Data (Including VoIP and Video Over IP) Handling:

A virtual cable modem resides inside the Wireless Access Point for every device or for a group of several devices served by the network. The virtual cable modem supports DOCSIS 1.0, DOCSIS 1.1, DOCSIS 2.0, DOCSIS 3.0 and/or other DOCSIS compatible specifications. Every time a mobile device needs to establish a connection with the CMTS in the head end or hub for data, voice or video IP streaming service, a virtual cable modem is created and the connection between the virtual cable modem and the CMTS is established in the same way as defined in the DOCSIS specifications (ranging, registration, security etc.), using unique MAC address of each mobile device. Since, in accordance with present invention, CMTS assumes that the mobile device has an assigned cable modem, the authorization procedure for a mobile device may be the same as for a fixed devices, (e.g. cable modem, IP phone, etc.). In certain embodiments of the invention, the Wireless Access Point may have, in addition, a dedicated cable modem for configuration and monitoring with unique MAC address of the Wireless Access Point.

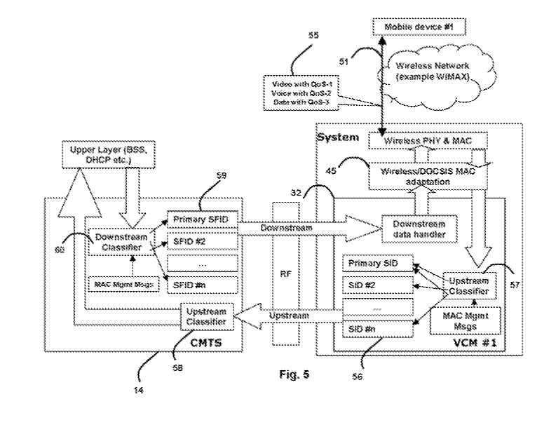

Referring to FIG. 5, there is illustrated a generalized workflow of QoS handling in accordance with certain embodiment of the present invention.

The QoS mechanism allows the delivery of different services, downstream and upstream, guaranteeing low jitter and low delay for video and voice services. All QoS modes provide by the DOCSIS will be mapped to the wireless network QoS, guaranteeing the same QoS all the way from the head-end to the end user device. The adaptation 45 will be done on both upstream and downstream channels. The CMTS 14 will grant the virtual modem 32 to use an upstream slot for data delivering (video, data or voice) depending on the QoS that a specific service 55 been assigned during the registration or later when a session for data transferred is initiated like in the case of VoIP call. Each service been assign by the downstream classifier 60 at the CMTS to service flow ID (SFID) 59, and each service flow has different QoS priority for example, Video: SFID-2 mapped to (QoS-1, Voice: SFID-3 mapped to QoS-2, and Data: primary SFID mapped to QoS-3. On the upstream, the upstream classifier assigns each service to a service flow ID 56, which might have different QoS e.g. Video: QoS-1 mapped to SID2, Voice: QoS-2 mapped to SID3, and Data QoS-3 mapped to primary SID. On the wireless link 51, Video has QoS-1, Voice has QoS-2 and Data QoS-3.

The virtual modem 54 follows the DOCSIS standard steps of ranging, establishing IP connectivity, establishing time of date, and registration. Upon completion of the registration, if the mobile device is allowed to access the network, the connection is done using the cable modem of the Wireless Access Point 35. The registration is done with the device MAC address exactly as it is done with any cable modem. In case the service is not authorized, the virtual cable modem stores that information, and the Wireless Access Point blocks the device and does not forward data to the CMTS. If the authentication passes, the device receives an IP address from the Dynamic Host Configuration Protocol (DHCP) server using the virtual modem and than proceeds with the authorization (base on subscriber profile such as allowed services, quality of service etc.). The data on the upstream is transmitted from the Wireless Access Point either by using the virtual modem upstream channel for that device, or by using the upstream channel of the Wireless Access Point's physical cable modem.

A Virtual Media Terminal Adapter (MTA) supporting the PacketCable specifications can reside inside the Wireless Access Point. This virtual MTA performs initialization and authorization with the PacketCable Call Management Server (CMS). The CMS can then route calls from and to the mobile phone, and authorize the Virtual Cable Modem and the CMTS to process the call data.

The downstream channel from the CMTS is shared between all devices and therefore the data is multicast over the wireless network to the devices. On the upstream, each device is granted by the CMTS whenever an upstream data transfer of a specific service, video, data, or voice is needed.

A conversion between the DOCSIS MAC and the 3G or WiFi or WiMAX or 802.20 MAC is also done in the Wireless Access Point and security is enforced on the wireless data using the encryption mechanisms defined by the standards. A DES, Triple DES, DVB common scrambling or other proprietary scrambling methods can also be applied on the downstream data.

As mention above, a single cable modem 35 is also implemented in the Wireless Access Point, in addition to the virtual cable modems. Using this method, higher-level software is needed to allow the login of the device into the IP network at the head-end since the CMTS will pass thru this data without applying authentication and authorization mechanisms. The higher application can then refuse to authorize the service, and block it. This method is good for “visitors”, people who are not regular subscribers of the MSO that provides the wireless service, but still would like to get the services.

The mobile or nomadic device initiates 44 the service whenever a service is needed (in case of a mobile phone whenever it turned on). It initiates the service with all the Wireless Access Points that are within reception range, but transmits the data only to the one with the strongest reception. While the device moves, and the coverage area changes, it initiates connections with other Wireless Access Points and terminates connection with Wireless Access Point that are no longer with reception range.

In the case of mobile phones, when an incoming call is received, the system in the head-end uses a dedicated software to know exactly to which Wireless Access Points the mobile phone is registered, and transmits the signaling and data either to those Wireless Access Points or to the one Wireless Access Point with the best transmission. In any case, the mobile phone replies only to one Wireless Access Point.

In order to support future mobile phones that use only Session Initiation Protocol (SIP), a conversion between PacketCable standard and SIP may be done in the Wireless Access Point. The SIP protocol can also be used from the mobile device all the way to the head end and in this case the above conversion is not needed. A virtual Multimedia Terminal Adapter (MTA) for each mobile phone is implemented in the Wireless Access Point such that towards the DOCSIS network, the mobile phone is treated as if it has an MTA built into it. Yet, towards the mobile phone, the SIP protocol is used. The location of the phone is identified based on the MAC address that is part of the PacketCable standard and not the SIP. Once the call is initiated, the data is pass thru the Wireless Access Point without any conversion to the CMTS.

### CONCLUSION, RAMIFICATIONS, AND SCOPE

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention, may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. In a hybrid wireless/cable network providing at least one IP service, a Wireless Access Point system capable of authenticating a communication device via DOCSIS and/or DOCSIS-compatible protocol and providing the IP service to the communication device in accordance with a result of the authentication.

2. The Wireless Access Point system of claim 1 wherein the communication device is a mobile device.

3. The Wireless Access Point system of claims 1 or 2 comprising one or more virtual cable modems capable of receiving a wireless MAC address of at least one communication device and converting the wireless MAC address into a DOCSIS MAC address associated with the communication device.

4. The Wireless Access Point system of claim 3 wherein the virtual cable modem is capable of sending the converted MAC address via DOCSIS and/or DOCSIS-compatible protocol and facilitating an access to at least one IP service associated with said MAC address.

5. In a hybrid wireless/cable network providing at least one IP service, a method of facilitating an access of a communication device to the IP service, the method comprising authenticating a communication device via DOCSIS and/or DOCSIS-compatible protocol and providing the IP service in accordance with a result of authentication.

6. The method of claim 5 wherein the communication device is a mobile device.

7. The method of claims 5 or 6 further comprising receiving a wireless MAC address of at least one communication device and converting the wireless MAC address into a DOCSIS MAC address associated with the communication device.

8. The method of claim 7 further comprising sending the converted MAC address via DOCSIS and/or DOCSIS-compatible protocol and facilitating an access to at least one IP service associated with said MAC address.

9. In a hybrid wireless/cable network providing at least one IP service, a method of providing IP service for at least one communication device, wherein the access to the IP service is provided in accordance with any one of claims 5-8.
